(19) United States
(12) Patent Application Publication
(10) Pub. No.: US 2025/0236313 A1
(43) Pub. Date: Jul. 24, 2025

(54) Apparatus for Controlling Autonomous Driving and Method Thereof

(71) Applicants: Hyundai Motor Company, Seoul (KR); Kia Corporation, Seoul (KR); HYUNDAI AUTOEVER Corp., Seoul (KR)

(72) Inventors: Yu Ho Choi, Hwaseong-si (KR); Jang Soon Han, Hwaseong-si (KR); Bong Ju Kim, Yongin-si (KR); Kyung Taek Kim, Anyang-si (KR)

(21) Appl. No.: 18/912,840

(22) Filed: Oct. 11, 2024

(30) Foreign Application Priority Data
Jan. 18, 2024 (KR) 10-2024-0008145

(51) Int. Cl. B60W 60/00; B60W 50/00

(52) U.S. Cl. CPC B60W 60/001; B60W 50/00; B60W 2050/0005

(57) ABSTRACT

An apparatus for controlling autonomous driving of a vehicle is introduced. The apparatus may comprise a processor operatively connected to a storage, the storage configured to store one or more instructions, when executed by the processor, cause the apparatus to collect data associated with controlling autonomous driving of the vehicle, determine, based on a time point at which a trigger signal was generated while collecting the data, priority of collected data, store, based on the determined priority, the collected data, wherein data collected prior to the time point is given a priority higher than data collected after the time point, and change, based on the stored data, controlling method of autonomous driving of the vehicle.

### CROSS-REFERENCE TO RELATED APPLICATION

This application claims priority to and the benefit of Korean Patent Application No. 10-2024-0008145, filed in the Korean Intellectual Property Office on Jan. 18, 2024, the entire contents of which are incorporated herein by reference.

### TECHNICAL FIELD

The present disclosure relates to an autonomous driving control apparatus and an autonomous driving control method, and more particularly, to a technique for efficiently storing driving data of autonomous vehicles.

### BACKGROUND

An autonomous vehicle refers to a vehicle that can drive on its own by recognizing a driving environment, determining risks, and planning a riving path without driver intervention. Such self-driving vehicles are equipped with data loggers that record vehicle driving conditions while driving in an autonomous driving mode.

For stable driving of autonomous vehicles, more and more data are needed, and technology to efficiently store and manage such data may be developed. For example, in accordance with established laws and regulations, the autonomous driving control apparatus may store at least some of the data generated (or identified) while performing autonomous driving control for the vehicle in memory.

However, as autonomous driving technology develops, there is a problem that the size and storage time of data that the autonomous driving control apparatus wishes to store increases. Furthermore, in response to a case where a limit situation occurs, such as a situation in which data must be stored continuously or a situation in which the autonomous driving control apparatus is reset, a method for the autonomous driving control apparatus to efficiently store and manage driving data may be used.

### SUMMARY

According to the present disclosure, an apparatus for controlling autonomous driving of a vehicle, the apparatus may comprise a processor operatively connected to a storage, the storage configured to store one or more instructions, when executed by the processor, cause the apparatus to collect data associated with controlling autonomous driving of the vehicle, determine, based on a time point at which a trigger signal was generated while collecting the data, priority of collected data, store, based on the determined priority, the collected data, wherein data collected prior to the time point is given a priority higher than data collected after the time point, and change, based on the stored data, controlling method of autonomous driving of the vehicle.

The apparatus, wherein the one or more instructions, when executed by the processor, further cause the apparatus to store data collected from the time point to a second time point that is earlier than the time point, wherein older data is stored before more recent data, and store data collected from the time point to a third time point that is later than the time point, wherein more recent data is stored before older data.

The apparatus, wherein the one or more instructions, when executed by the processor, further cause the apparatus to set, based on at least one of a functional safety (ASIL) level or a data size, a storage priority for the collected data.

The apparatus, wherein the one or more instructions, when executed by the processor, further cause the apparatus to store at least some of the collected data in a first memory included in the storage during autonomous driving of the vehicle, and move, based on the trigger signal, the data stored in the first memory to a second memory of the storage.

The apparatus, wherein the one or more instructions, when executed by the processor, further cause the apparatus to determine a priority of data stored in the first memory at the time point, and store, based on the determined priority, a highest priority data in the second memory, wherein the highest priority data is data collected from the time point to another time point that is earlier than the time point.

The apparatus, wherein the one or more instructions, when executed by the processor, further cause the apparatus to extract, based on a temporal order, data from a memory, wherein the temporal order is different from an order by which data was stored.

The apparatus, wherein the one or more instructions, when executed by the processor, further cause the apparatus to determine, based on a change amount of data collected over a period from the time point to a second time point, a priority of the data collected over the period.

The apparatus, wherein the one or more instructions, when executed by the processor, further cause the apparatus to determine, based on an increment of an average value of the change amount of data, a weight, and determine, based on at least one of the weight or a functional safety level, the priority by determining urgency or importance of data collected over the period.

The apparatus, wherein the one or more instructions, when executed by the processor, further cause the apparatus to receive, based on the urgency or importance of data, feedback on priority information, and use, based on the weight, the priority information.

The apparatus, wherein the one or more instructions, when executed by the processor, further cause the apparatus to determine, based on whether a signal strength of data collected during a period from the time point to a second time point exceeding a threshold or based on whether the signal comprises a predetermined value or a predetermined pattern, a priority of data collected over the period.

The apparatus, wherein the one or more instructions, when executed by the processor, further cause the apparatus to store data collected from the time point to a second time point that is earlier than the time point, and wherein older data is stored before more recent data.

According to the present disclosure, a method performed by a processor for controlling autonomous driving of a vehicle, the method may comprise collecting a data associated with controlling autonomous driving of the vehicle, determining, based on a time point at which a trigger signal was generated while collecting the data, priority of collected data, storing, based on the determining the priority, data, wherein data collected from the time point is given a priority higher than data collected after the time point, and changing, based on the stored data, controlling method of autonomous driving of the vehicle.

The method, wherein the storing data comprises storing first data before storing second data, wherein the first data is collected before the time point and the second data is collected at or after the time point.

The method, wherein the storing data comprises storing data collected from the time point to a second time point that is earlier than the time point, wherein older data is stored before more recent data, and storing data collected from the time point to a third time point that is later than the time point, wherein more recent data is stored before older data.

The method, wherein the storing data comprises setting, based on at least one of a functional safety (ASIL) level or a data size, a storage priority for the collected data.

The method, wherein the storing data comprises storing at least some of the collected data in a first memory during autonomous driving of the vehicle, and moving, based on the trigger signal, the data stored in the first memory to a second memory.

The method, wherein the storing data comprises determining, based on a change amount of data collected over a period from the time point to a second time point, a priority of the data collected over the period.

The method, wherein the storing data comprises determining, based on whether a signal strength of data collected during a period from the time point to a second time point exceeds a threshold or based on whether the signal comprises a predetermined value or a predetermined pattern, a priority of data collected over the period.

According to the present disclosure, an apparatus for controlling autonomous driving of a vehicle, the apparatus may comprise at least one processor, and at least one storage configured to store one or more instructions, when executed by the at least one processor, cause the apparatus to perform autonomous driving control of the vehicle, collect data associated with the autonomous driving control of the vehicle, store, in at least one buffer of a memory of a first type, collected data obtained via the collecting data, wherein the collected data is configured to be stored in a first format, during the autonomous driving control of the vehicle, determine, based on a time point at which a trigger signal is generated while collecting the data, priority of the collected data, convert, based on the determined priority, at least one first piece of the collected data to a second format for storing in a memory of a second type, wherein the at least one first piece of the collected data is collected prior to the time point, and store, based on the determined priority, the at least one first piece of the collected data in the memory of the second type prior to storing at least one second piece of the collected data in the memory of the second type, wherein data collected prior to the time point is given a priority higher than data collected after the time point, and wherein the at least one second piece of the collected data is collected after the time point.

The apparatus of claim 19, wherein the one or more instructions, when executed by the at least one processor, further cause the apparatus to discard the at least one second piece of the collected data from the memory of the first type without storing the at least one second piece of the collected data in the memory of the second type, and control, based on the stored at least one first piece of the collected data, autonomous driving of the vehicle.

### BRIEF DESCRIPTION OF THE DRAWINGS

FIG. 1 shows an example configuration of an autonomous driving control apparatus.

FIG. 2 shows an example autonomous driving control apparatus.

FIG. 3 shows an example of data stored by an autonomous driving control apparatus.

FIG. 4 shows an example of priority for each storage item.

FIG. 5 shows an example data storage method in response to autonomous driving control.

FIG. 6 shows an example mechanism for determining a data storage order in response to autonomous driving control.

FIG. 7 shows another example mechanism for determining a data storage order in response to autonomous driving control.

FIG. 8 shows an example data storage order.

FIG. 9 shows an example computing system.

### DETAILED DESCRIPTION

Hereinafter, some examples of the present disclosure will be described in detail with reference to example drawings. It should be noted that in adding reference numerals to constituent elements of each drawing, the same constituent elements include the same reference numerals as possible even though they are indicated on different drawings. In describing an example of the present disclosure, when it is determined that a detailed description of the well-known configuration or function associated with the example of the present disclosure may obscure the gist of the present disclosure, it will be omitted.

In describing constituent elements according to an example of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those which are generally understood by those skilled in the technical field of the disclosure to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

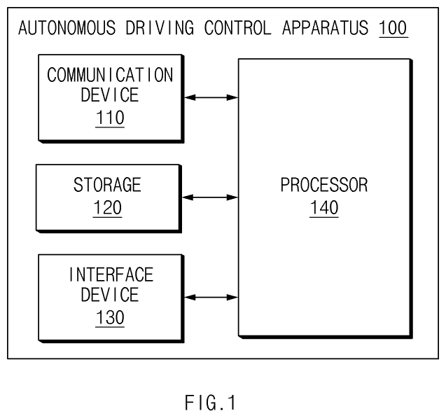

Hereinafter, various examples of the present disclosure will be described in detail with reference to FIG. 1 to FIG. 9.

FIG. 1 shows an example configuration of an autonomous driving control apparatus.

According to an example of the present disclosure, the autonomous driving control apparatus 100 may be implemented within or separately from a vehicle. In this case, the autonomous driving control apparatus 100 may be integrally formed with internal control units of the vehicle, or may be implemented as a separate hardware device to be connected to control units of the vehicle by a connection means. For example, the autonomous driving control apparatus 100 may be implemented integrally with the vehicle, may be implemented in a form that is installed or attached to the vehicle as a configuration separate from the vehicle, or a part thereof may be implemented integrally with the vehicle, and another part may be implemented in a form that is installed or attached to the vehicle as a configuration separate from the vehicle.

The autonomous driving control apparatus 100 may be configured to collect data related to autonomous driving control of an autonomous vehicle, in response to a trigger signal occurring while collecting data, to determine priority of the collected data based on a first time point (e.g., 0 second) at which the trigger signal occurs, and to first store highest priority data, and in the instant case, to first store data from the first time point (e.g., 0 seconds) at which the trigger signal occurs to a second time point (e.g., −30 seconds), and then to store data from the first time point to a third time point (e.g., 30 seconds). The trigger signal corresponds to a predefined event (e.g., (e.g., collision detections, lane departure warnings, pedestrian detection, obstacle detections, sudden braking events, speed limit exceedance events, traffic sign recognition events, vehicle-to-everything (V2X) communication events, road condition change detections like detection of hazardous road conditions like ice, oil spills, or potholes, driver monitoring system alerts indicating, for example, the driver showing signs of drowsiness, distraction, or other impairments, sensor malfunction detections, navigation system alerts indicating, for example, detection of an unplanned route change or off-course event, geofencing alerts indicating entering or existing a predefined geographical area, vehicle intrusion detections indicating unauthorized access or intrusion into the vehicle, emergency vehicle detections indicating presence of an emergency vehicle nearby, etc.), and the autonomous driving control apparatus 200 may be configured to store data, based on the trigger signal, related to the event.

The autonomous driving control apparatus 100 may include a communication device 110, a storage 120, an interface device 130, and a processor 140. According to an example of the present disclosure, the autonomous driving control apparatus 100 may be implemented as a single unit by coupling components with each other, and some components may be omitted.

A configuration of the autonomous driving control apparatus 100 illustrated in FIG. 1 is merely an example, and examples of the present disclosure are not limited thereto. For example, the autonomous driving control apparatus 100 may further include components not illustrated in FIG. 1 (e.g., at least one of a sensor device, a display device, a notification device, or any combination thereof).

The communication device 110 is a hardware device implemented with various electronic circuits to transmit and receive signals through a wireless or wired connection, and may transmit and receive information based on in-vehicle devices and in-vehicle network communication techniques. As an example of the present disclosure, the in-vehicle network communication techniques may include Controller Area Network (CAN) communication, Local Interconnect Network (LIN) communication, flex-ray communication, and the like.

The communication device 110 is a hardware device implemented with various electronic circuits to transmit and receive signals through a wireless or wired connection, and may transmit and receive information with internal devices such as vehicles, ships, airplanes, UAMs, and electric kickboards, equipped with displays, based on network communication techniques. As an example of the present disclosure, the in-vehicle network communication techniques may include Controller Area Network (CAN) communication, Local Interconnect Network (LIN) communication, flex-ray communication, and the like.

The communication device 110 may perform V2X communication. The V2X communication may include communication between vehicle and all entities such as V2V (vehicle-to-vehicle) communication which refers to communication between vehicles, V2I (vehicle to infrastructure) communication which refers to communication between a vehicle and an eNB or road side unit (RSU), V2P (vehicle-to-pedestrian) communication, which refers to communication between user equipment (UE) held by vehicles and individuals (pedestrians, cyclists, vehicle drivers, or occupants), and V2N (vehicle-to-network) communication.

Furthermore, the communication device 110 may include a mobile communication module, a wireless Internet module, a short-range communication module, etc. for communication with outside of the vehicle.

The mobile communication module may be configured to perform communication using technical standards or communication methods for mobile communication (e.g., Global System for Mobile communication (GSM), Code Division Multi access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 4th Generation mobile telecommunication (4G), 5th Generation mobile telecommunication (5G), etc.

The wireless Internet module refers to a module for wireless Internet access, and may be configured to perform communication through Wireless LAN (WLAN), Wireless-Fidelity (Wi-Fi), Wi-Fi direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), etc.

The short-range communication module may support short-range communication by using at least one of Bluetooth™, radio frequency identification (RFID), infrared data association (IrDA), ultra wideband (UWB), ZigBee, near field communication (NFC), a wireless universal serial bus (USB) technique, or any combination thereof.

For example, the communication device 110 may transmit stored data to the outside of the vehicle in response to a case where a trigger occurs.

The storage 120 may store data and/or algorithms used for the processor 140 to operate, and the like.

For example, the storage 120 may store one or more instructions that allow the autonomous driving control apparatus 100 to perform various operations in response to execution by the processor 140. For example, the storage 120 and the processor 140 may be implemented as one chipset. The processor 140 may include at least one of a communication processor or a modem.

For example, the storage 120 may store various information related to the autonomous driving control apparatus 100. For example, the storage 120 may store information related to an operation history of the processor 140. For example, the storage 120 may store information related to statuses and/or operations of components (e.g., at least one of an engine control unit (ECU), a sensor device, a drive device, the storage 120, an input device, a notification device, or any combination thereof) of the vehicle.

For example, the storage 120 may include a plurality of different types of storage devices (e.g., a random-access memory (RAM), an embedded multi-media card (eMMC), a data scratch pad RAM (DSPR), a data local memory unit (DLMU), a local memory unit (LMU), or a default application memory (DAM), etc. For example, the storage 120 may include at least one of a volatile memory (e.g., random-access memory (RAM), a high bandwidth memory (HBM), or other first types of memories accessible by one or more processors for faster processing) or a non-volatile memory (e.g., embedded multi-media card (eMMC), a solid state drive (SSD), a hard disk drive, or other second types of non-volatile storage devices, which may provide slower processing than the first types of memories), or any combination thereof.

For example, the RAM may temporarily (or transiently) store data (e.g., driving data) regarding an operation of the autonomous driving control apparatus 100 and/or a target vehicle to be controlled by the autonomous driving control apparatus 100. The RAM may include, e.g., at least one buffer that holds data while it is being transferred from one place to another. The RAM may operate to access data significantly faster than eMMC. But, the eMMC may be able to store a lot more data than the RAM and thus more cost-effective for large storage capacities compared to the RAM.

For example, the autonomous driving control apparatus 100 may store at least one node in a RAM that is made by dividing data collected (or identified) by unit time while performing autonomous driving control for a vehicle.

For example, the eMMC may include an embedded multimedia card or a portable multimedia card (e.g., a portable hard drive or solid state drive (SSD), etc.). The eMMC may store data for a longer period of time than the RAM, for example. For example, the eMMC may be implemented as a separate memory chip separately from the RAM or independent of the RAM.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may include a soft key implemented on the display.

The interface device 130 may be implemented as a head-up display (HUD), a cluster, an audio video navigation (AVN), or a human machine interface (HM), a human machine interface (HMI).

The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In the present disclosure, the output device may output platooning information such as sensor failure information, lead vehicle information, group rank information, a platooning speed, a destination, a waypoint, a path, and the like.

In the instant case, the display may include at least one of a liquid crystal display (LCD), a thin film transistor liquid crystal display (TFT LCD), an organic light-emitting diode display (OLED display), a flexible display, a field emission display (FED), and a 3D display.

For example, the interface device 130 may output stored data in response to a case where a trigger occurs and allow a user to check it.

The processor 140 may be electrically connected to the communication device 110, the storage 120, the interface device 130, and the like, may electrically control each component, and may be an electrical circuit that executes software commands, thereby performing various data processing and calculations described below.

The processor 140 may be configured to process signals transmitted between each component of the autonomous driving control apparatus 100 and to perform overall control such that each component may normally perform its function. The processor 140 may be implemented in the form of hardware, software, or a combination of and software. For example, the processor 140 may be implemented as a microprocessor, but the present disclosure is not limited thereto. For example, it may be, e.g., an electronic control unit (ECU), a micro controller unit (MCU), or other subcontrollers mounted in the vehicle.

The processor 140 may be configured to collect (or obtain) various data generated (or identified) while performing autonomous driving control for a vehicle.

For example, data related to autonomous driving control may include driving data related to driving of a vehicle. The driving data may include, e.g., information related to at least one of a vehicle driving environment, a driving speed, events that occur while driving, or any combination thereof.

For example, the processor 140 may be configured to temporarily store at least some of the data collected while performing autonomous driving control in a designated driving section (e.g., highway) for the vehicle in a buffer included in the storage 120.

The processor 140 may be configured to collect data related to autonomous driving control of the vehicle. In the instant case, the data related to autonomous driving control may include lidar measurement results, camera shooting results, radar measurement results, map data, vehicle speed, steering angle, GPS, position information, turn signal on/off information, etc.

In response to a case where a trigger signal occurs while collecting data, the processor 140 may be configured to determine priority of the collected data based on a first time point (e.g., 0 second) at which the trigger signal occurs, and may preferentially store data with a highest priority, and in the instant case, may first store data from the first time point at which the trigger signal occurred up to a second time point (e.g., −30 seconds) in a backward direction. For example, the priority of data such as lidar measurement results, camera shooting results, radar measurement results, map data, vehicle speed, steering angle, GPS, position information, and turn signal on/off information may be determined and stored in advance.

The processor 140 may be configured to set a storage priority for the collected data based on at least one of a functional safety (ASIL) level, a data size, or a combination thereof. For example, the processor 140 may be configured to set the storage priority of the collected data by combining the functional safety (ASIL) level and the data size, and the functional safety level is a standard for expressing fatality of a vehicle and indicates exposure and severity of risk by level, and thus as the risk and severity increase in the functional safety level, it may be stored first.

The processor 140 may be configured to first store the data with the highest priority from the first time point at which the trigger signal occurs (e.g., 0 seconds) to the second time point (e.g., −30 seconds) in a backward chronological direction, and may be configured to store information from the first time point at which the trigger signal occurred to a third time point (e.g., 30 seconds) in a forward chronological direction.

While performing autonomous driving control, the processor 140 may be configured to store at least some of the collected data in a first memory 212 included in the storage, and to store the data stored in the first memory in a second memory 214 included in the storage in response to the occurrence of the trigger signal.

The processor 140 may be configured to determine the priority of data stored in the first memory 212 at the time point of trigger signal occurrence, and to preferentially store the data with the highest priority among the data at the time point of trigger signal occurrence, and in the instant case, to first store data with the highest priority in reverse order from the time point of trigger signal occurrence to a predetermined time point.

The processor 140 may be configured to extract data according to a temporal order in response to a case of extracting data, even in a case where it is first stored in the backward chronological direction at the first time point at which the trigger signal occurs.

The processor 140 may be configured to determine the priority of the data from the first time point at which the trigger signal occurred to the second time point by using a change amount of data from the first time point at which the trigger signal occurred to the second time point.

The processor 140 may be configured to determine a weight according to an increment of an average value of the change amount of data, and determine the priority by determining urgency or importance of data from the first time point at which the trigger signal occurs to the second time point using at least one of a weight, a functional safety level, or a combination thereof. For example, data from 0 seconds, which is the first time point, to −30 seconds, which is the second time point, may be stored first, and in the instant case, the storage order may be determined by storing data of −20 to −21 seconds first and then data of −15 to −16 seconds according to urgency and importance instead of storing data from 0 seconds to −1 seconds first and then data from −1 seconds to −2 seconds first in a reverse order.

The processor 140 may be configured to receive feedback on priority information determined according to urgency or importance, and to use the priority information determined according to urgency or importance in response to determining the weight.

The processor 140 may be configured to determine the priority of data from the first time point at which the trigger signal occurred to the second time point by using whether a signal strength of the data from the first time point at which the trigger signal occurred to the second time point exceeds a predetermined threshold or whether the signal includes a predetermined value or a predetermined pattern.

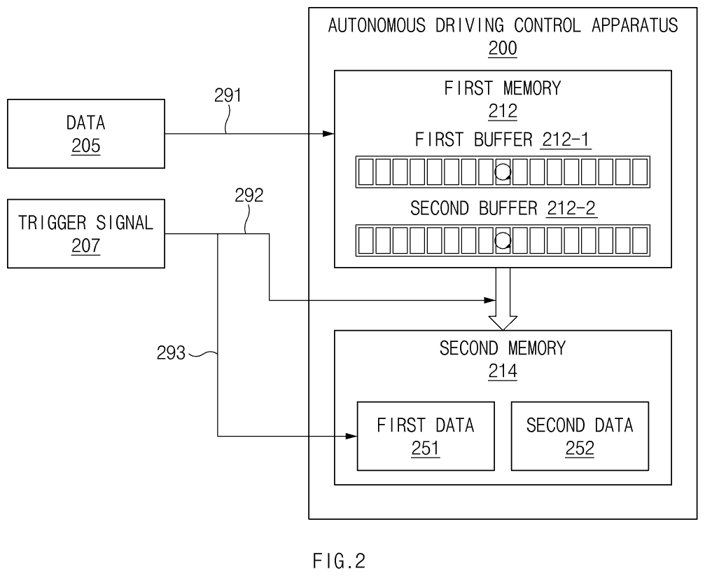

The processor 140 may be configured to store data in the reverse order from the first time point at which the trigger signal occurred to the second time point in response to the case where data from the first time point at which the trigger signal occurred to the second time point is first stored in the backward direction. For example, data from 0 seconds to −30 seconds may be stored first in the reverse order, and in the instant case, data from −29 seconds to −30 seconds may be stored in the reverse order in the order of data from 0 seconds to −1 seconds, data from −1 seconds to −2 seconds, and data from −2 seconds to −3 seconds. Conversely, in response to storing data from the first to the third time point, data from 0 to 1 second, data from 1 to 2 seconds, data from 2 to 3 seconds may be stored sequentially, and data from 29 to 30 seconds may be stored. FIG. 2 shows an example autonomous driving control apparatus.

According to an example, the autonomous driving control apparatus 200 (e.g., the autonomous driving control apparatus 100 of FIG. 1) may include a first memory 212 (e.g., RAM) and a second memory 214 (e.g., eMMC). For example, the first memory 212 and the second memory 214 may be implemented as a single device (e.g., the storage 120 of FIG. 1). For example, the first memory 212 and the second memory 214 may be operatively connected to a processor (e.g., processor 140 of FIG. 1). For example, the first memory 212 and the second memory 214 may be electrically connected to each other to transmit and receive data.

For example, the first memory 212 may include one or more buffers 212-1 and 212-2. For example, the first memory 212 may include a first buffer 212-1 and a second buffer 212-2.

Referring to reference number 291, according to an example, the autonomous driving control apparatus 200 may be configured to sequentially store data 205 generated (or acquired) while performing autonomous driving control for a vehicle in at least one buffer included in the first memory 212.

For example, the second memory 214 may include a storage space for storing data and/or a controller. The second memory 214 may be, e.g., an Embedded Multi-Media Card (eMMC).

Referring to reference numbers 292 and 293, according to an example, the autonomous driving control apparatus 200 may be configured to identify (or detect) a trigger signal 207. In response to a case where the trigger signal 207 is detected, the autonomous driving control apparatus 200 may be configured to store data in the second memory 214 in different ways according to a type of the trigger signal.

Referring to reference number 292, for example, in response to a case where the trigger signal 207 is identified, the autonomous driving control apparatus 200 may be configured to store second data 252 corresponding to the trigger signal 207 among the data stored in one or more buffers 212-1 and 212-2 in the second memory 214.

For example, the autonomous driving control apparatus 200 may be configured to move and store the second data 252 corresponding to the identified designated period from the one or more buffers 212-1 and 212-2 to the second memory 214, based on a time point at which the trigger signal 207 is identified (or occurred). In the instant case, in response to a case where the second data 252 is personal information such as GPS position information, it may be encrypted and stored for data integrity.

Referring to reference number 293, for example, in response to a case where the trigger signal 207 corresponds to a predefined event, the autonomous driving control apparatus 200 may be configured to immediately store the first data 251 related to the event in the second memory 214 without going through the first memory 212 (or the one or more buffers 212-1 and 212-2).

The trigger signal may include, e.g., at least one of a system activation or inactivation signal, an event data recorder (EDR), an emergency maneuver (EM), a transition demand (TD), a minimum risk maneuver (MRM), a vehicle failure signal, or any combination thereof.

Furthermore, the first data 251 may include law storage data.

The second data 252 may include data generated (or acquired) while the autonomous driving control apparatus 200 performs autonomous driving control for the vehicle.

In this way, in a case where the trigger signal 207 is detected due to an accident, etc., the data in the first memory 212 may be stored in the second memory 214, and in the instant case, a problem occurs such as power supply being cut off due to an accident, a power supply to the autonomous driving control apparatus 200 may be cut off before the data in the first memory 212 is stored in the second memory 214, and thus important data may not be stored.

Accordingly, according to the present disclosure, a method of storing important data in the second memory 214 in advance before the power supply is cut off due to an accident is disclosed.

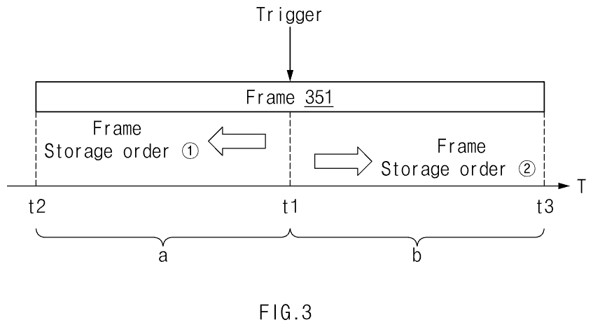

FIG. 3 shows an example of data stored by an autonomous driving control apparatus.

Referring to FIG. 3, according to an example, a situation may occur in which the autonomous driving control apparatus (e.g., the autonomous driving control apparatus 100 of FIG. 1) may be used to store a frame 351 corresponding to data related to autonomous driving control in memory, and data to be stored based on the trigger signal may be defined as a frame. In the instant case, the trigger signal may occur immediately before or immediately after the accident occurs. Furthermore, according to the situation, a system shutdown process may be performed in the event of a power supply failure before data is stored. In the instant case, it becomes difficult to store data for back-tracking.

According to an example, the autonomous driving control apparatus 100 may be configured to store data in reverse order based on a first time point t1 at which a state transition occurs according to time priority.

A frame size of the data 205 generated (or acquired) while performing autonomous driving control is large, and thus the autonomous driving control apparatus 100 may be configured to preferentially store data with high priority rather than storing all data from the beginning according to the situation.

Furthermore, the autonomous driving control apparatus 100 may be configured to preferentially store data for reproducing an accident situation even in a situation where power supply is difficult, making it possible to obtain data for reproducing an accident situation later.

The time priority may be stored by giving priority to data before the trigger signal is generated t2 and data after the trigger signal is generated t3 based on the time point t1 at which the trigger signal occurs. For example, the data of −30 seconds, which is the second time point, is stored first at the first time point t1 at which the trigger signal occurs, and data of +30 seconds, which is a third time point, may be stored from the first time point t1 at which the trigger signal occurs. For example, a trigger signal is generated at the first time point t1 at which a collision accident is detected. Data collected prior to the collision accident is given a higher priority than data collected right after the collision accident. For example, the data (e.g., data indicating lane departure warnings, driver monitoring system alerts, sensor malfunction signals, etc.) collected prior to the collision accident may be more helpful to analyze causes of the collision accident than the data collected (e.g., data indicating collision, air-bag deployment events, etc.) after the collision accident.

For example, the autonomous driving control apparatus may be configured to identify that the trigger signal occurred at the first time point t1. The autonomous driving control apparatus may be configured to identify the second time point t2 that is a time “a” (e.g., 30 seconds) before the first time point t1, and may identify a third time point t3 that is a time “b” (e.g., 30 seconds) from the first time point t1.

The autonomous driving control apparatus may be configured to identify a period from the first time t1 to the second time t2 as a first period corresponding to the trigger signal, and to identify a period from the first time point t1 to the third time point t3 as a second period corresponding to the trigger signal.

For example, the autonomous driving control apparatus may be configured to store the frame 351, which is data for a first period, in the second memory 214 in a first direction (e.g., backward from the first time point t1) based on the trigger signal being identified. Subsequently, the autonomous driving control apparatus 100 may be configured to store the frame 351 for the second period in the second memory 214 in a second direction (e.g., forward from the first time point t1) immediately after the frame 351 for the first period in the first direction (e.g., backward from the first time point t1) is stored in the second memory 214.

In the instant case, the autonomous driving control apparatus 100 may be configured to store data corresponding to the frame 351, among various other data temporarily stored in the buffer, in a memory storage device (e.g., eMMC) that is separate from the buffer.

In this way, the autonomous driving control apparatus 100 may be configured to sequentially store data immediately before (t2) the time point around the first time point (t1) at which the trigger signal occurred, that is, data immediately before (t2) at which the trigger signal occurred, in a reverse order, and to store sequentially data after (t3), so key data for identifying a cause of an accident may be stored accurately first, which may be advantageous for analyzing the cause of the accident in response to extracting the accident data later.

In response to a case where an accident occurs, the data immediately before the accident occurs is important for identifying the cause of the accident, and thus the autonomous driving control apparatus 100 may be configured to store data in reverse chronological order based on the first time point at which the trigger signal occurred. For example, data between 0 seconds and 1 second, data between 1 second and 2 seconds, and data between 2 seconds and 3 seconds may be stored in reverse order to store data from 29 seconds to 30 seconds.

Furthermore, the autonomous driving control apparatus 100 may be configured to extract data in chronological order to facilitate identification of the cause of the accident in order to extract the data even in a case where data is stored in reverse chronological order based on the first time point where the trigger signal occurred.

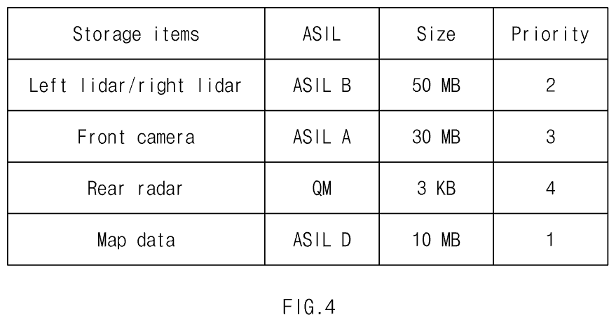

FIG. 4 shows an example of priority for each storage item.

Referring to FIG. 4, the priority of each stored item may be stored in advance, and the priority may be determined according to automotive software integrity levels (ASIL) and frame sizes of the stored items. In the instant case, a smaller priority value may indicate data that must be stored first.

The ASIL is a vehicle function safety level that can be identified into four levels by A, B, C, and D, and the autonomous driving control apparatus 100 may be configured to determine the priority for storing data according to the ASIL. ASIL level A is the lowest safety requirement. This level indicates that the impact of a potential failure is minimal, and the safety measures are less stringent. ASIL level B indicates a moderate safety requirement. The impact of a failure at this level is considered to be of medium severity, requiring moderate safety measures. ASIL level C indicates a high safety requirement. Failures at this level may have a significant impact, and therefore, more stringent safety measures are required. ASIL level D is the highest safety requirement. This level indicates the highest risk and severity of potential failures, asking the most rigorous safety measures. These levels help ensure that appropriate safety practices are applied based on the potential impact of failures in automotive systems.

FIG. 4 shows an example of determining priority according to the ASIL level and data sizes, but the present disclosure is not limited to thereto, and data storage priority may also be determined by considering other conditions. The priority for storing such data may be determined in advance by experimental values.

For example, in a case where storage items include left lidar/right lidar data, front camera data, rear radar data, map data, etc., the ASIL is low, data with the smallest data size has the highest priority, and the ASIL is Level D and has a highest priority (e.g., priority 1) for storing map data with a data size of 10 MB.

Furthermore, in the data-logger logic, a data field may be added to check priority and storage.

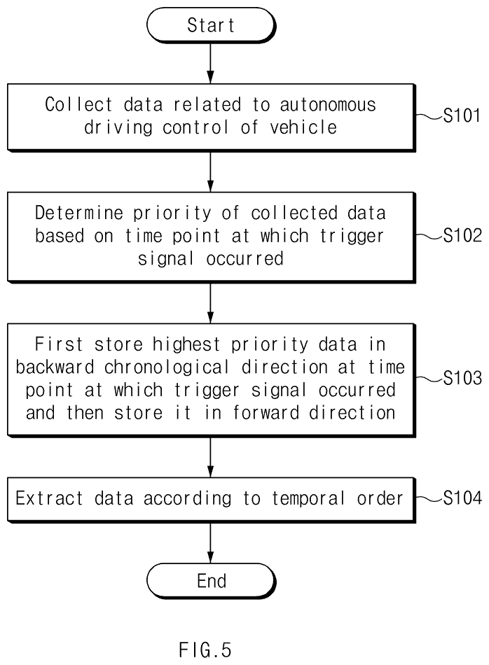

Hereinafter, an autonomous driving control method according to an example of the present disclosure will be described with reference to FIG. 5. FIG. 5 shows an example autonomous driving control method.

Hereinafter, it is assumed that the autonomous driving control apparatus 100 of FIG. 1 performs processes of FIG. 5. In addition, in the description of FIG. 5, operations described as being performed by a device may be understood as being controlled by the processor 140 of the autonomous driving control apparatus 100. In following examples, operations of steps S101 to S104 may be performed sequentially, but are not necessarily performed sequentially. For example, an order of each operation may be changed, and at least two operations may be performed in parallel.

Furthermore, content that corresponds to or overlaps the content described above with respect to FIG. 5 may be briefly described or omitted.

Referring to FIG. 5, the autonomous driving control apparatus 100 may be configured to collect data related to autonomous driving control of the vehicle (S101). For example, the autonomous driving control apparatus 100 may be configured to use a sensor device (not illustrated) to obtain (or collect) sensor data generated while performing autonomous driving control on a vehicle. In the instant case, the collected data may be temporarily stored in the first memory 212 (first buffer and second buffer) of FIG. 2.

Thereafter, in response to a case where an accident occurs and a trigger signal occurs, the autonomous driving control apparatus 100 may be configured to move the data stored in the first memory 212 to the second memory and store it, and there may be a case where the power supply is interrupted after an accident occurs and a storing operation cannot be performed, so in response to a case where the trigger signal occurs, important data may be stored first.

Accordingly, the autonomous driving control apparatus 100 may be configured to determine the priority of the collected data based on the first time point t1 at which the trigger signal occurred (S102). For example, in response to a case where lidar data, camera data, radar data, map data, etc. are collected based on the first time point t1 at which the trigger signal occurred, the autonomous driving control apparatus 100 may be configured to preferentially store map data based on a pre-stored priority table as shown in FIG. 4.

The autonomous driving control apparatus 100 may be configured to first store the data with the highest priority in the backward chronological direction at the first time point t1 at which the trigger signal occurred and then store it in the forward direction (S103). For example, in order to store map data, the autonomous driving control apparatus 100 may be configured to store map data from the first time point t1 at which the trigger signal occurred to the second time point t2 in the backward direction as illustrated in FIG. 3, and to store map data from the first time point t1 at which the trigger signal occurred to the third time point t3 in the forward direction.

Thereafter, the autonomous driving control apparatus 100 may be configured to extract data according to a temporal order (S104). For example, the map data is stored in the reverse direction in step S103, the autonomous driving control apparatus 100 may be configured to help analyze the cause of the accident by extracting and providing the temporal order in the forward direction.

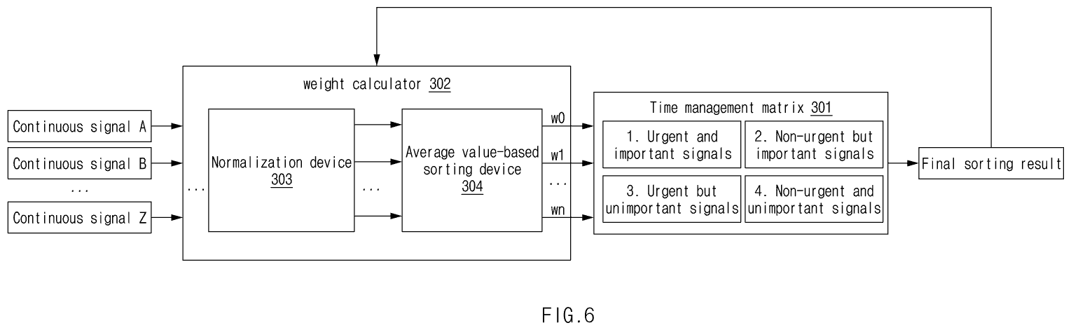

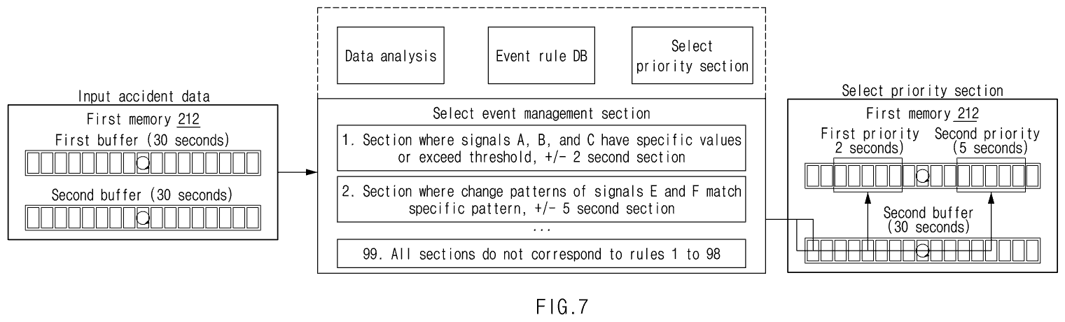

The above-described FIG. 5 discloses data storage according to priority using the pre-stored priority table, but hereinafter, an example of determining priority for data storage will be described in detail with reference to FIG. 6 and FIG. 7. Furthermore, in the description of FIG. 6 and FIG. 7, operations described as being performed by a device may be understood as being controlled by the processor 140 of the autonomous driving control apparatus 100.

FIG. 6 shows an example mechanism for determining a data storage order in response to autonomous driving control.

The autonomous driving control apparatus 100 may be configured to assign a time priority weight by considering a change amount of data with continuous properties among properties (continuous or discontinuous) of storage target data of the data logger.

This is because the change amount of data in the data that has a greatest impact on the accident before/after a certain period of time after the accident occurs is smaller than that in the data with less impact on the accident, and thus different weights may be applied by sorting data with a small change amount from data with a large change amount.

For example, the accident data from 0 seconds to −30 seconds is not stored only in reverse order as illustrated in FIG. 3 in response to a case where accident data from 0 seconds, which is the first time point at which the trigger signal occurred, to −30 seconds is entered in reverse order, but among the signals of the accident data for 30 seconds, the signal with a high change amount is determined as the signal with high priority, and the signals of the accident data for 30 seconds may be divided and stored according to priority.

To determine priority in this way, the processor 140 of the autonomous driving control apparatus 100 may include a weight calculator 302 and a time management matrix 301.

In response to a case where continuous signals A, B, C, . . . , and Z (e.g., lane departure warning signal, obstacle detection signal, sudden braking signal, . . . , collision detection signal, etc.) are input from 0 seconds, which is the first time point at which the trigger signal occurred, to −30 seconds in reverse order, the weight calculator 302 may determine an increment of an average value of change amounts obtained after normalizing the continuous signals A, B, C, . . . , and Z, and may determine weights of the continuous signals A, B, C, . . . , and Z according to the increment of the average value. To this end, the weight calculator 302 may include a normalization device 303 and an average value-based sorting device 304.

The normalization device 303 may transform continuous signals A, B, C, . . . , and Z according to predetermined rules to make them easier to use. The average value-based sorting device 304 may determine an average value of change amounts of normalized signals to determine weights w0, w1, . . . , and wn according to an increment of the average value. That is, the average value-based sorting device 304 may determine the weights in the order of the change amount of the average value over a certain period of time.

The time management matrix 301 may output a final sorting result obtained by classifying continuous signals A, B, C, . . . , and Z into urgent and important signals (e.g., collision detection signal, emergency maneuver activation signal, pedestrian detection signal, etc.), non-urgent but important signals (e.g., system update notification signal, maintenance required alert signal, driver monitoring system alert signal, etc.), urgent but unimportant signals (e.g., weather change alert signal, low windshield washer fluid warning signal, Bluetooth disconnect alert signal, etc.), and non-urgent and unimportant signals (e.g., entertainment system notification signal, social media notification signal, low cabin air quality alert signal, etc.) according to the weight and ASIL input from the weight calculator 302. In the instant case, the final sorting result may include priority information of consecutive signals A, B, C, . . . , and Z.

That is, the time management matrix 301 may classify continuous signals according to urgency and importance using the input weights. For example, the time management matrix 301 may use weights to determine whether data storage is urgent, and may use ASIL to determine the importance of data storage.

The time management matrix 301 may feedback the final sorting result to the weight calculator 302, and the weight calculator 302 may determine the weight using the final sorting result.

In this way, in response to the case where accident data is input from 0 seconds, which is the first time point at which the trigger signal occurred, to −30 seconds, which is the second time point, in reverse order, the autonomous driving control apparatus 100 may be configured to determine the priority of signals according to the amount of signal change in each section of accident data for 30 seconds and store the signals according to priority instead of storing 30 seconds of accident data in reverse order as illustrated in

FIG. 3. For example, in a case of storing data from 0 to −30 seconds, the data from −20 to −22 seconds may be stored first in response to a case where a signal change amount in the data from −20 to −22 seconds is largest.

FIG. 7 shows another example mechanism for determining a data storage order in response to autonomous driving control.

Storage target data of a data-logger may be divided into signals that are highly correlated with actual accidents (collisions) and signals that are not. By using high or low accident correlation of these signals, it is possible to select an important section that should be stored first in the event of an accident.

Accordingly, the autonomous driving control apparatus 100 may be configured to define various rules to determine whether the accident correlation is high or low, and for example, in response to a case where the data signal at the time point of trigger occurrence has a specific value, a case where the intensity of the data signal exceeds a threshold, or a case where the data signal contains a specific pattern, to define the case as having high relevance to the accident and preferentially store data signals with high relevance. In the instant case, predetermined rules may be stored in advance in the event rule database (DB) of the storage 120.

For example, as an example of a case where the data signal at the time point of trigger occurrence has a specific value, it may be defined that the accident correlation is high in a case where the vehicle speed is 60 kph. Furthermore, as an example of a case where strength of the data signal exceeds a threshold, strength of a radar signal increases as the object gets closer, and thus the accident relevance may be defined as high in response to a case where the strength of the radar signal is greater than a predetermined threshold. Furthermore, as an example of a case where the strength of the data signal exceeds the threshold, the accident relevance may be defined as high in response to a case where a rotation angle of steering wheels exceeds a predetermined threshold. Furthermore, in response to a case where the data signal has a specific pattern, a relationship between accidents may be determined using a pattern of repeated turning on and off of a turn signal and a pattern of changes in vehicle speed. For example, the accident correlation may be defined as high in response to a case where a pattern of the vehicle driving at more than 60 kph in a 10-second cycle and suddenly stopping and suddenly lowering to 20 kph or less is repeated three or more times.

Furthermore, in response to a case where a section or time point showing similarity to a rule exists within 30 seconds of data, the autonomous driving control apparatus 100 may be configured to first determine the section and the length of the section and store it. A method of writing these rules may be created through results of preliminary analysis of accumulated data of various accidents (collisions).

For example, in response to a case where accident data from 0 seconds, which is the first time point at which the trigger signal occurred, to −30 seconds is entered in reverse order, the accident data for 30 seconds is not stored in reverse order as illustrated in FIG. 3, but accident data for 30 seconds may be divided into sections, determine priority, and be divided and stored according to priority. FIG. 7 shows an example of dividing 30 seconds of accident data into first and second priorities.

For example, in response to a case where data signals A, B, C, D, E, and F are present in the accident data from 0 seconds at which the trigger signal occurred to −30 seconds in reverse order, the autonomous driving control apparatus 100 may be configured to determine priority based on whether the strength of each data signal exceeds a threshold and whether a change pattern of the data signal matches a predetermined pattern.

FIG. 7 shows an example in which a time point at which the data signals A, B, and C are specific values or the strength of the data signal exceeds the threshold (e.g. +/−2 seconds) is determined as the first priority, and a section at which the change pattern of the signals E and F matches a specific pattern (+/−5 seconds) is determined as the second priority, and reflecting more diverse conditions, data from 0 seconds, the first time point at which the trigger signal occurred, to −30 seconds, the second time point, may be stored according to priority.

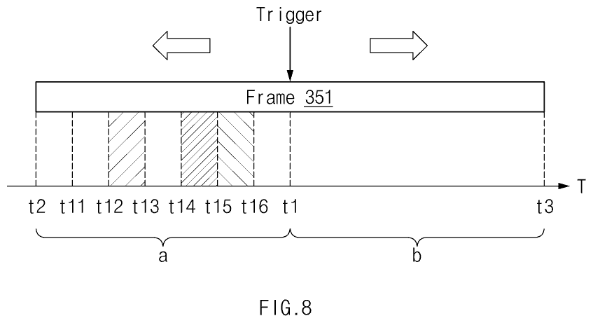

FIG. 8 shows an example data storage order.

A process of determining the priority of data from the first time point t1 at which the trigger signal occurs to −30 seconds will be described in detail as follows with reference to FIG. 8.

For example, first map data may be stored in reverse order from the first time point t1 at which the trigger signal occurred to the second time point t2 in reverse order, and in the instant case, the data from the first time point t1 to the second time point t2 in reverse order may be divided into the sections t2, t11, t12, t13, t14, t15, t16, and t1, and priorities may be determined by determining whether the data signal in each section has a specific value or a specific pattern, or whether the strength of the data signal exceeds a predetermined threshold. For example, in response to a case where the first time point t1 is 0 seconds and the first time point t2 is −30 seconds, instead of storing data from 0 to −30 seconds in reverse order, data from 0 to −30 seconds may be divided into certain sections (e.g., 30), and it may be determined whether the data signal included in each section contains a specific value or a specific pattern, or whether the strength of the data signal exceeds a predetermined threshold.

In response to a case where the data signal stored in a section from t12 to t13 contains a specific value, it may be determined as a first priority, in response to a case where the strength of the data signal stored in a section from t14 to t15 is greater than a threshold, it may be determined as a second priority, and in response to a case where the data signal stored in a section from t15 to t16 contains a specific pattern, it may be determined as a third priority, and thus the data stored in the section from t12 to t13 may be stored in the second memory 214 as the first priority, the data stored in the section from t14 to t15 may be stored in the second memory 214 as the second priority, the data stored in the section from t15 to t16 may be stored in the second memory 214 in the third priority, and remaining sections may also be prioritized and stored from t1 to t2, and then as described above for the section from t1 to t3, the priority of data from the first time point t1 at which the trigger signal occurs to the second time point t2 may be determined and stored in the second memory 214.

In this way, according to the present disclosure, by preferentially storing data immediately before and after the trigger signal occurs, important data may be stored first and the stored data may be used for later accident cause analysis even in a case where it is difficult to save data due to power supply cutoff due to an accident, etc.

Furthermore, according to the present disclosure, the data immediately before the trigger signal occurs may be stored as priority, and in the instant case, the data immediately before the trigger signal occurs may be stored in the backward chronological direction.

Furthermore, according to the present disclosure, by storing the data immediately before the trigger signal occurs with priority, and for example, by storing the data just before the trigger signal occurs in reverse order, or by determining the priority using pre-determined rules, the amount of change in the signal, etc., and storing the data according to the determined priority, priority may be determined by determining the importance and urgency of data in more detail.

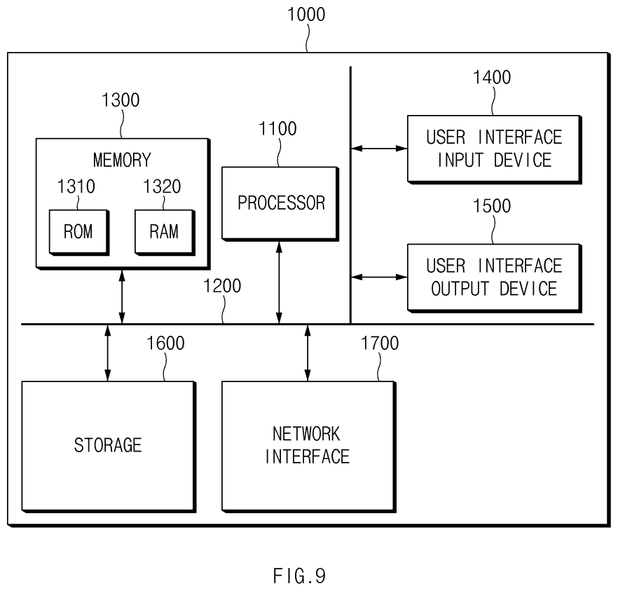

FIG. 9 shows an example computing system.

Referring to FIG. Referring 9, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the examples included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

Examples of the present disclosure attempt to provide an autonomous driving control apparatus and an autonomous driving control method, configured for preferentially securing important data at a time point at which a trigger signal occurs by first saving the data immediately before the trigger signal occurs.

Examples of the present disclosure attempt to provide an autonomous driving control apparatus and an autonomous driving control method, configured for preferentially securing time data around a time point at which a trigger signal occurs by storing data from a first time point (e.g., 0 seconds) at which the trigger signal occurs to a second time point (e.g., −30 seconds) in a backward direction, and then storing the data in a forward direction from the first time point at which the trigger signal occurs to a third time point (e.g., saves up to 30 seconds) of data.

Exemplary examples of the present disclosure attempt to provide an autonomous driving control apparatus and an autonomous driving control method, configured for storing data in reverse order from a time point at which a trigger signal occurs in response to a case of first storing data from the time point at which the trigger signal occurs to a second time point in a backward direction.

Examples of the present disclosure attempt to provide an autonomous driving control apparatus and an autonomous driving control method, configured for determining priority of data from a time point at which a trigger signal occurs to a second time point in a backward direction according to a change amount of the signal and a predetermined rule and storing it in response to a case of first storing data from the time point at which the trigger signal occurs to the second time point in the backward direction.

The technical objects of the present disclosure are not limited to the objects mentioned above, and other technical objects not mentioned may be clearly understood by those skilled in the art from the description of the claims.

An example of the present disclosure provides an autonomous driving control apparatus including: a storage configured to store one or more instructions; and a processor operatively connected to the storage, wherein according to the one or more instructions, executed by the processor, the autonomous driving control apparatus is configured to collect data on autonomous driving control of a vehicle, to determine priority of the collected data based on a first time point at which a trigger signal occurred in response to a case where the trigger signal occurs while collecting the data, and to first store highest priority data, and in the instant case, to first store data from the first time point at which the trigger signal occurred to a second time point in a backward direction.

In an example of the present disclosure, the processor may be configured to first store the highest priority data from the first time point at which the trigger signal occurs to the second time point in a backward chronological direction, and then to store information from the first time point at which the trigger signal occurred to a third time point in a forward chronological direction.

In an example of the present disclosure, the processor may be configured to set a storage priority for the collected data based on at least one of a functional safety (ASIL) level, a data size, or a combination thereof.

In an example of the present disclosure, the processor may be configured to store at least some of the collected data in a first memory included in the storage while performing autonomous driving control, and to store the data stored in the first memory in a second memory included in the storage in response to occurrence of the trigger signal.

In an example of the present disclosure, the processor may be configured to determine the priority of data stored in the first memory at the time point of trigger signal occurrence, and to preferentially store the highest priority data among the data at the time point of trigger signal occurrence, and in the instant case, to first store the highest priority data in reverse order from the time point of trigger signal occurrence to a predetermined time point.

In an example of the present disclosure, the processor may be configured to extract data according to a temporal order in response to a case of extracting data, even in a case where it is first stored in the backward chronological direction at the first time point at which the trigger signal occurred.

In an example of the present disclosure, the processor may be configured to determine the priority of the data from the first time point at which the trigger signal occurred to the second time point by using a change amount of data from the first time point at which the trigger signal occurred to the second time point.

In an example of the present disclosure, the processor may be configured to determine a weight according to an increment of an average value of the change amount of data, and determine the priority by determining urgency or importance of data from the first time point at which the trigger signal occurred to the second time point using at least one of a weight, a functional safety level, or a combination thereof.

In an example of the present disclosure, the processor may be configured to receive feedback on priority information determined according to urgency or importance, and to use the priority information determined according to urgency or importance in response to determining the weight.

In an example of the present disclosure, the processor may be configured to determine the priority of data from the first time point at which the trigger signal occurred to the second time point by using whether a signal strength of the data from the first time point at which the trigger signal occurred to the second time point exceeds a predetermined threshold or whether the signal includes a predetermined value or a predetermined pattern.

In an example of the present disclosure, the processor may be configured, in response to first storing data from the first time point at which the trigger signal occurred to the second time point in the backward direction, to store data in the reverse order from the first time point at which the trigger signal occurred to the second time point.

An exemplary example of the present disclosure provides an autonomous driving control method including: collecting, by a processor, data on autonomous driving control of a vehicle; determining, by the processor, priority of the collected data based on a first time point at which a trigger signal occurred in response to a case where the trigger signal occurs while collecting the data; and first storing, by the processor, highest priority data, and in the instant case, first storing data from the first time point at which the trigger signal occurred to a second time point in a backward direction.

In an example of the present disclosure, the first storing of the data to the second time point may include storing, by the processor, data in reverse order from the first time point at which the trigger signal occurred to the second time point.

In an example of the present disclosure, the first storing of the data to the second time point may include first storing, by the processor, the highest priority data from the first time point at which the trigger signal occurs to the second time point in a backward chronological direction, and then storing information from the first time point at which the trigger signal occurred to a third time point in a forward chronological direction.

In an example of the present disclosure, the first storing of the data to the second time point may include setting, by the processor, a storage priority for the collected data based on at least one of a functional safety (ASIL) level, a data size, or a combination thereof.

In an example of the present disclosure, the first storing of the data to the second time point includes: storing, by the processor, at least some of the collected data in a first memory while performing autonomous driving control; and storing the data stored in the first memory in a second memory in response to occurrence of the trigger signal.

In an example of the present disclosure, the first storing of the data to the second time point may include determining, by the processor, the priority of the data from the first time point at which the trigger signal occurred to the second time point by using a change amount of data from the first time point at which the trigger signal occurred to the second time point.

In an example of the present disclosure, the determining the priority of the data to the second time point may include determining, by the processor, a weight according to an increment of an average value of the change amount of data, and determine the priority by determining urgency or importance of data from the first time point at which the trigger signal occurred to the second time point using at least one of a weight, a functional safety level, or a combination thereof.

In an example of the present disclosure, the determining the priority of the data to the second time point may include receiving, by the processor, feedback on priority information determined according to urgency or importance, and to use the priority information determined according to urgency or importance in response to determining the weight.

In an example of the present disclosure, the first storing of the data to the second time point may include determining, by the processor, the priority of data from the first time point at which the trigger signal occurred to the second time point by using whether a signal strength of the data from the first time point at which the trigger signal occurred to the second time point exceeds a predetermined threshold or whether the signal includes a predetermined value or a predetermined pattern.

According to the present techniques, it may be possible to preferentially secure important data at a time point at which a trigger signal occurs by first saving the data immediately before the trigger signal occurs.

According to the present techniques, it may be possible to preferentially secure time data around a time point at which a trigger signal occurs by storing data from a first time point (e.g., 0 seconds) at which the trigger signal occurs to a second time point (e.g., −30 seconds) in a backward direction, and then storing the data in a forward direction from the first time point at which the trigger signal occurs to a third time point (e.g., saves up to 30 seconds) of data.

According to the present techniques, it may be possible to store data in reverse order from a time point at which a trigger signal occurs in response to a case of first storing data from the time point at which the trigger signal occurs to a second time point in a backward direction.

According to the present techniques, it may be possible to first store important data by further segmenting priorities, by determining priority of data from a time point at which a trigger signal occurs to a second time point in a backward direction according to a change amount of the signal and a predetermined rule and storing it in response to a case of first storing data from the time point at which the trigger signal occurs to the second time point in the backward direction.

Furthermore, various effects which may be directly or indirectly identified through the present specification may be provided.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed is:

1. An apparatus for controlling autonomous driving of a vehicle, the apparatus comprising:
a processor operatively connected to a storage;
the storage configured to store one or more instructions, when executed by the processor, cause the apparatus to:
collect data associated with controlling autonomous driving of the vehicle;
determine, based on a time point at which a trigger signal was generated while collecting the data, priority of collected data;
store, based on the determined priority, the collected data, wherein data collected prior to the time point is given a priority higher than data collected after the time point; and
change, based on the stored data, controlling method of autonomous driving of the vehicle.

2. The apparatus of claim 1, wherein the one or more instructions, when executed by the processor, further cause the apparatus to:
store data collected from the time point to a second time point that is earlier than the time point, wherein older data is stored before more recent data; and
store data collected from the time point to a third time point that is later than the time point, wherein more recent data is stored before older data.

3. The apparatus of claim 1, wherein the one or more instructions, when executed by the processor, further cause the apparatus to set, based on at least one of a functional safety (ASIL) level or a data size, a storage priority for the collected data.

4. The apparatus of claim 1, wherein the one or more instructions, when executed by the processor, further cause the apparatus to:
store at least some of the collected data in a first memory included in the storage during autonomous driving of the vehicle, and
move, based on the trigger signal, the data stored in the first memory to a second memory of the storage.

5. The apparatus of claim 4, wherein the one or more instructions, when executed by the processor, further cause the apparatus to:
determine a priority of data stored in the first memory at the time point; and
store, based on the determined priority, a highest priority data in the second memory, wherein the highest priority data is data collected from the time point to another time point that is earlier than the time point.

6. The apparatus of claim 1, wherein the one or more instructions, when executed by the processor, further cause the apparatus to extract, based on a temporal order, data from a memory, wherein the temporal order is different from an order by which data was stored.

7. The apparatus of claim 1, wherein the one or more instructions, when executed by the processor, further cause the apparatus to determine, based on a change amount of data collected over a period from the time point to a second time point, a priority of the data collected over the period.

8. The apparatus of claim 7, wherein the one or more instructions, when executed by the processor, further cause the apparatus to:
determine, based on an increment of an average value of the change amount of data, a weight; and
determine, based on at least one of the weight or a functional safety level, the priority by determining urgency or importance of data collected over the period.

9. The apparatus of claim 8, wherein the one or more instructions, when executed by the processor, further cause the apparatus to:
receive, based on the urgency or importance of data, feedback on priority information; and
use, based on the weight, the priority information.

10. The apparatus of claim 1, wherein the one or more instructions, when executed by the processor, further cause the apparatus to determine, based on whether a signal strength of data collected during a period from the time point to a second time point exceeding a threshold or based on whether the signal comprises a predetermined value or a predetermined pattern, a priority of data collected over the period.

11. The apparatus of claim 1, wherein the one or more instructions, when executed by the processor, further cause the apparatus to store data collected from the time point to a second time point that is earlier than the time point, and wherein older data is stored before more recent data.

12. A method performed by a processor for controlling autonomous driving of a vehicle, the method comprising:
collecting data associated with controlling autonomous driving of the vehicle;
determining, based on a time point at which a trigger signal was generated while collecting the data, priority of collected data;
storing, based on the determining the priority, data, wherein data collected from the time point is given a priority higher than data collected after the time point; and
changing, based on the stored data, controlling method of autonomous driving of the vehicle.

13. The method of claim 12, wherein the storing data comprises storing first data before storing second data, wherein the first data is collected before the time point and the second data is collected at or after the time point.

14. The method of claim 12, wherein the storing data comprises:
storing data collected from the time point to a second time point that is earlier than the time point, wherein older data is stored before more recent data; and
storing data collected from the time point to a third time point that is later than the time point, wherein more recent data is stored before older data.

15. The method of claim 12, wherein the storing data comprises
setting, based on at least one of a functional safety (ASIL) level or a data size, a storage priority for the collected data.

16. The method of claim 12, wherein the storing data comprises:
storing at least some of the collected data in a first memory during autonomous driving of the vehicle; and
moving, based on the trigger signal, the data stored in the first memory to a second memory.

17. The method of claim 12, wherein the storing data comprises determining, based on a change amount of data collected over a period from the time point to a second time point, a priority of the data collected over the period.

18. The method of claim 12, wherein the storing data comprises
determining, based on whether a signal strength of data collected during a period from the time point to a second time point exceeding a threshold or based on whether the signal comprises a predetermined value or a predetermined pattern, a priority of data collected over the period.

19. An apparatus for controlling autonomous driving of a vehicle, the apparatus comprising:
at least one processor; and
at least one storage configured to store one or more instructions, when executed by the at least one processor, cause the apparatus to:
perform autonomous driving control of the vehicle;
collect data associated with the autonomous driving control of the vehicle;
store, in at least one buffer of a memory of a first type, collected data obtained via collecting the data, wherein the collected data is configured to be stored in a first format;
during the autonomous driving control of the vehicle, determine, based on a time point at which a trigger signal is generated while collecting the data, priority of the collected data;
convert, based on the determined priority, at least one first piece of the collected data to a second format for storing in a memory of a second type, wherein the at least one first piece of the collected data is collected prior to the time point; and
store, based on the determined priority, the at least one first piece of the collected data in the memory of the second type prior to storing at least one second piece of the collected data in the memory of the second type, wherein data collected prior to the time point is given a priority higher than data collected after the time point, and wherein the at least one second piece of the collected data is collected after the time point.

20. The apparatus of claim 19, wherein the one or more instructions, when executed by the at least one processor, further cause the apparatus to:
discard the at least one second piece of the collected data from the memory of the first type without storing the at least one second piece of the collected data in the memory of the second type; and
control, based on the stored at least one first piece of the collected data, autonomous driving of the vehicle.
